(19) United States
(12) Patent Application Publication
(10) Pub. No.: US 2016/0017956 A1
(43) Pub. Date: Jan. 21, 2016

(54) UNBALANCED SHAFT

(71) Applicants: Riad Bauch, Wurzburg (DE); Daniel Ludwig, Gochsheim (DE)

(72) Inventors: Riad Bauch, Wurzburg (DE); Daniel Ludwig, Gochsheim (DE)

(73) Assignee: Aktiebolaget SKF, Goteborg (SE)

(21) Appl. No.: 14/803,525

(22) Filed: Jul. 20, 2015

(30) Foreign Application Priority Data
Jul. 18, 2014 (DE) 102014213995.3

(51) Int. Cl. F16F 15/26

(52) U.S. Cl. CPC F16F 15/267

(57) ABSTRACT

An unbalanced shaft for compensating inertial forces and/or moments of inertia for a reciprocating internal combustion engine includes at least one shaft section and a bearing journal adjacent to the at least one shaft section and an unbalance mass disposed on the shaft section. The bearing journal is formed from at least two parts including a first solid bearing segment and a second solid bearing segment, and a center of gravity of the shaft section and the bearing journal is eccentric to an axis of rotation of the unbalanced shaft. The first solid bearing segment includes a portion projecting into the second solid bearing segment and the second solid bearing segment include a portion projecting into the first solid bearing segment such that the first and the second solid bearing segment are secured at least axially relative to each other.

### CROSS-REFERENCE

This application claims priority to German patent application no. 10 2014 213 995.3 filed on Jul. 18, 2014, the contents of which are fully incorporated herein by reference.

### TECHNOLOGICAL FIELD

The present disclosure is directed to an unbalanced shaft for compensating and/or offsetting inertial forces and/or moments of inertia. The shaft may be used, for example, in a reciprocating internal combustion engine.

### BACKGROUND

An unbalanced shaft is known from the prior art, for example, from DE 10 2007 027 990 (a family member of US 2010/192894), which includes a shaft section and a bearing journal. The bearing journal is configured as a partial cylinder, and this configuration contributes to the unbalance/eccentricity of the shaft. It is also known from DE 10 2009 035 112 (a family member of US 2011/023809) to configure bearing journals as two solid bearing journal segments so that one bearing journal segment is formed from metal and the other bearing journal segment is formed from plastic. While such shaft designs significantly reduce the total weight of the unbalanced shaft, they may disadvantageously allow the two bearing segments to move relative to one another. However, if only one partial cylinder is provided, a corresponding partial-cylinder casing must be formed on the partial cylinder in order to provide a running surface for rolling elements of a rolling-element bearing in order to support the unbalanced shaft in its housing. However, such a design is very complex and increases production and assembly costs.

### SUMMARY

One aspect of the present disclosure is therefore to provide a reduced-weight unbalanced shaft that is easy to manufacture.

According to the disclosure an unbalanced shaft is provided for compensating or offsetting inertial forces and/or moments of inertia, in particular in a reciprocating internal combustion engine. The unbalanced shaft includes at least one shaft section and a bearing journal adjacent thereto. The shaft includes an unbalanced mass that gives the shaft an eccentric center of gravity relative to an axis of rotation of the shaft. Furthermore, the bearing journal is formed from at least two parts and includes first and second solid bearing segments. The first and the second solid bearing segments are configured such that they engage or plug into each other so they are secured at least axially relative to each other. This axial securing helps prevent the bearing segments from sliding or moving relative to each other (as sometimes occurs in the prior art), and also keeps them in position when they are exposed to the vibrations that often occur during the operation of an internal combustion engine. As a result, the radial bearing assembly is less susceptible to failure caused by relative movement between the bearing segments, and a reliable and durable radial bearing assembly results.

According to a further advantageous embodiment, the first and second bearing segments are configured to engage into each other such that they are at least partially radially secured in their relative positions. Since conventional bearing segments are often both axially and radially movable, particularly during assembly, the disclosed embodiment helps prevent both axial and radial movement.

It is particularly advantageous if the connection between the first and second bearing segments is configured as a plug connection. Such plug connections are particularly simple to design and can secure the bearing segments axially and/or radially with respect to each other in a simple manner. It is also particularly advantageous if one of the bearing segments is configured to include connecting lugs, preferably lugs that engage in complementarily recesses on the other bearing segment.

The connecting lugs are preferably located radially inside the outer periphery of the bearing journal, and they may be formed, for example, by mass elements on the unbalanced shaft. Forming the connection radially inside the bearing journal helps provide a cylindrical raceway for the unbalanced shaft (on the cylindrical outer surface of the bearing journal,) that is as interruption-free as possible.

According to a further exemplary embodiment, at least one of the bearing segments is manufactured from an injectable, moldable, or injection-moldable material, in particular a plastic. The bearing journal can thereby be provided with a light material in exactly the region where it is lightly loaded. Furthermore, using the injectable material a very simple design can be provided for the plug connection between the first and the second bearing segments. In particular the first solid bearing segment can be manufactured such that the second bearing segment is overmolded onto the first bearing segment. This results in a particularly simple and economical manufacturing method for the solid first bearing segment.

Furthermore, the material of the first bearing segment should have a lower density than the material of the second bearing segment. The second bearing segment can thereby be made heavier than the first bearing segment so that the bearing journal itself also has a center of gravity eccentric to an axis of rotation of the compensating shaft. This also contributes to unbalance and allows smaller unbalance masses to be used on the shaft section.

According to a further advantageous exemplary embodiment, the bearing journal is provided with a cylindrical outer surface that serves as a running surface for rolling elements of a rolling-element bearing which rolling elements are radially supported by and make line contact with the unbalanced shaft. The transitions between the bearing segments are not parallel to the contact line of the rolling elements and the bearing journal, but rather extend at least partially at an angle thereto. Thus, despite the two-part construction of the bearing, journal the rolling elements experience no unevenness as they roll over the transitions. As a result the running smoothness can be increased.

When two different materials having different coefficients of thermal expansion are used, an interruption or gap between the bearing segments may be needed, or sometimes a tolerance gap is present. The present disclosure allows for the presence of such a gap without adversely affecting the behavior of the rolling elements.

Further advantages and advantageous embodiments are defined in the claims, the drawings, and the description.

In the following description, the invention is described in more detail with reference to the exemplary embodiments. Here the embodiments are purely exemplary in nature and are not intended to define the scope of the application. The scope is defined solely by the appended claims.

### BRIEF DESCRIPTION OF THE DRAWINGS

FIG. 1 is a schematic perspective sectional view through a compensating shaft according to an embodiment of the present disclosure.

FIG. 2 is a schematic partial view of a bearing journal of the compensating shaft of FIG. 1.

### DETAILED DESCRIPTION

In the following discussion, identical or functionally equivalent elements are designated by the same reference numbers.

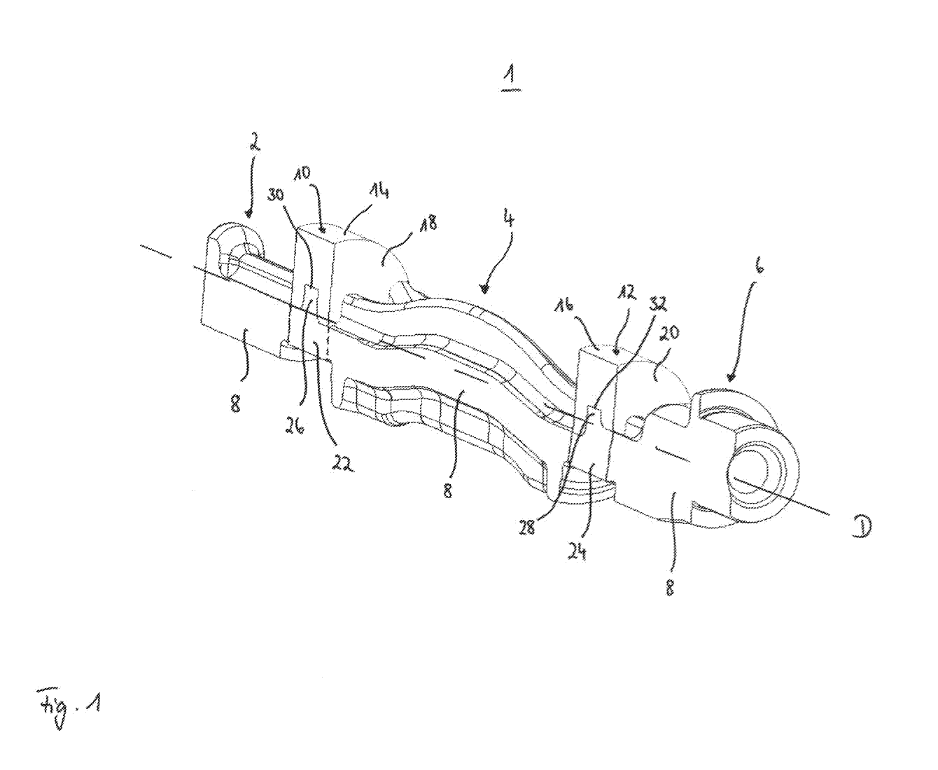

FIG. 1 shows a three-dimensional sectional view through an unbalanced shaft 1. The shaft 1 includes a plurality of shaft sections 2, 4, and 6 and is rotatably supported along an axis of rotation D. Unbalanced masses 8 are disposed on each of the shaft sections 2, 4, and 6, and these masses give the shaft a center of gravity that is eccentric to the axis of rotation D. Furthermore, FIG. 1 shows that the unbalanced shaft 1 includes bearing journals 10, 12 on which the shaft can be rotatably supported. In this case, the bearing journals 10, 12 usually serve as inner running surfaces for line contact rolling elements (not depicted) of rolling-element bearings. Thus the cylindrical outer surfaces 14, 16 of the bearing journals 10, 12 also serve as running surfaces for the rolling elements. A “rolling-element bearing with line contact” is understood to mean all types of rolling-element bearings whose running surfaces make contact with a support surface along a line. These include, for example, radial needle roller bearings, cylindrical roller bearings, tapered roller bearings and toroidal roller bearings. Ball bearings are not included, however, since their spherical rolling elements contact a raceway only at a point. Nevertheless, the inventive unbalanced shaft could also be radially supported using ball bearings.

Furthermore, it can be seen in FIG. 1 that the bearing journals 10, 12 are formed of two parts and include a first solid bearing segment 18, 20 and a second solid bearing segment 22, 24. As can further be seen in FIG. 1, the first bearing segments 18, 20 and the second bearing segments 22, 24 engage into each other. To this end, radially-inner connecting lugs 26, 28 are formed on the second bearing segments 22, 24, and these engage into complementarily, radially-inner recesses 30, 32 of the first bearing segments 18, 20. This radially-inner, mutually engaging connection of the solid bearing segments to each other helps ensure that the bearing segments are axial secured in position, i.e. with respect to the axis of rotation D, and at least partially secured in the radial direction as well.

It is particularly preferred that the first bearing segments 18, 20 are manufactured from a plastic material and fitted together with the second bearing segments 22, 24. Alternatively or additionally the first bearing segments 18, 20 can be formed by overmolding them onto the second bearing segments 22, 24.

As can further be seen from FIG. 1, the second bearing segments 22, 24 may also be integral with the unbalanced shaft 1.

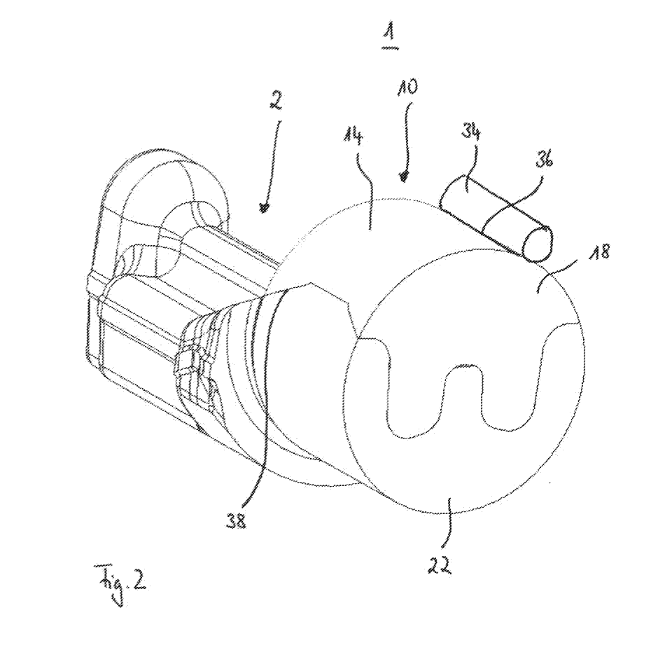

FIG. 2 is a detail view of the unbalanced shaft 1 of in FIG. 1, showing the bearing journal 10. The bearing journal 10 and the partial view of the unbalanced shaft 1 are no longer depicted in sectional view, but rather in three-dimensional view. Furthermore, in FIG. 2 a rolling element 34 is schematically depicted, which rolling element is part of a rolling-element bearing with line contact (not depicted) radially supporting the unbalanced shaft 1. It will be appreciated that the outer cylinder surface 14 of the bearing journal 10 serves as a running surface for the rolling elements 34 and is contacted by the rolling elements 34 along a line 36.

Furthermore, FIG. 2 shows that the running surface 14 includes an interruption 38 formed where the first bearing segment 18 and the second bearing segment 22 abut against each other. This interruption 38 is advantageously at least partially angled with respect to the contact line 36 of the rolling element. The rolling element 34 is thus always supported by the running surface 14, and this helps create a very smooth running surface, and thus smooth running, for the rolling elements 34. In addition, the interruption 8 can even be designed as a tolerance gap for accommodating a non-uniform thermal expansion of the two bearing segments 18, 22 due to the different coefficients of thermal expansion of their different materials. It can also be seen in FIG. 2 that both bearing segments 18, 22 are pluggable-into each other and are thus secured axially, and in part radially, against moving.

Overall, using the inventive unbalanced shaft 1 a weight-reduced unbalanced shaft can be provided, which is particularly easy to manufacture because the bearing segments 18, 22 only need to be plugged into each other. Simultaneously the bearing segments are radially and axially secured against movement, so that problems caused by the relative movement of these elements can be reduced or substantially prevented.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved unbalanced shafts.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Unbalanced shaft

2, 4, 6 Shaft sections

8 Unbalance mass

10, 12 Bearing journal

14, 16 Running surface

18, 20 First bearing segment

22, 24 Second bearing segment

26, 28 Connecting lug

30, 32 Connecting recess

34 Rolling elements

36 Line contact

38 Surface interruption

1. An unbalanced shaft for compensating inertial forces and moments of inertia for a reciprocating internal combustion engine, comprising:
at least one shaft section and a bearing journal adjacent to the at least one shaft section, and
an unbalance mass disposed on the shaft section,
wherein the bearing journal comprises at least two parts including a first solid bearing segment and a second solid bearing segment,
wherein a center of gravity of the shaft section and the bearing journal is eccentric to an axis of rotation of the unbalanced shaft, and
wherein the first solid bearing segment includes a portion projecting into the second solid bearing segment and the second solid bearing segment include a portion projecting into the first solid bearing segment such that the first and the second solid bearing segment are secured at least axially relative to each other.

2. The unbalanced shaft according to claim 1, wherein the first and the second bearing segments are configured such that they are at least partially secured radially relative to each other.

3. The unbalanced shaft according to claim 1, wherein the portion of the first solid bearing segment and the portion of the second solid bearing segment are disposed radially inside an outer periphery of the bearing journal.

4. The unbalanced shaft according to claim 1, wherein the portion of the first solid bearing segment and the portion of the second solid bearing segment form a plug connection between the first and the second bearing segments.

5. The unbalanced shaft according to claim 1, wherein the portion of the first solid bearing segment comprises a plug receivable in a complementary recess of the second solid bearing segment.

6. The unbalanced shaft according to claim 1, wherein at least the first bearing segment is manufactured from an injectable material, a moldable material, or an injection-moldable material.

7. The unbalanced shaft according to claim 1, wherein at least the first bearing segment is manufactured from a plastic.

8. The unbalanced shaft according to claim 6, wherein the first bearing segment is overmolded onto the second bearing segment.

9. The unbalanced shaft according to claim 1, wherein a material of the first solid bearing segment has a lower density than a material of the second solid bearing segment.

10. The unbalanced shaft according to claim 1, wherein at least the first bearing journal includes a cylindrical outer surface configured to form an inner running surface for rolling elements of a rolling-element bearing with line contact, and wherein at least a portion of a transition formed in the running surface between the first solid bearing segment and the second solid bearing segment is angled relative to a line along which the rolling elements make contact with the inner running surface.

11. The unbalanced shaft according to claim 1,
wherein the portion of the first solid bearing segment and the portion of the second solid bearing segment form a plug connection between the first and the second bearing segment,
wherein the portion of the first solid bearing segment comprises a plug receivable in a complementary recess of the second solid bearing segment,
wherein at least the first bearing segment is manufactured from a plastic,
wherein the first bearing segment is overmolded onto the second bearing segment,
wherein a material of the first solid bearing segment has a lower density than a material of the second solid bearing segment, and
wherein at least the first bearing journal includes a cylindrical outer surface configured to form an inner running surface for rolling elements of a rolling-element bearing with line contact, and wherein at least a portion of a transition formed in the running surface between the first solid bearing segment and the second solid bearing segment is angled relative to the line along which the rolling elements make contact with the inner running surface.

12. An unbalanced shaft for compensating inertial forces and moments of inertia for a reciprocating internal combustion engine, comprising:
at least one shaft section and a bearing journal adjacent to the at least one shaft section configured to support the at least one shaft section for rotation about an axis of rotation, and
at least one mass disposed on the shaft section such that a center of mass of the unbalanced shaft is radially offset from the axis of rotation,
wherein the bearing journal comprises a first solid bearing segment formed from a first material and a second solid bearing segment formed from a second material different than the first material, and
wherein the first solid bearing segment includes a first projection and the second solid bearing segment include a first recess complementary to the first projection, the first projection extending into the first recess and securing the first solid bearing segment against axial movement relative to the second solid bearing segment.

13. The unbalanced shaft according to claim 12, wherein at least the first bearing journal includes a cylindrical outer surface configured to form an inner running surface for rolling elements of a rolling-element bearing with line contact, and wherein at least a portion of a transition formed in the running surface between the first solid bearing segment and the second solid bearing segment is angled relative to a line along which the rolling elements make contact with the inner running surface.

14. The unbalanced shaft according to claim 13, wherein the transition includes a center portion parallel to the line along which the rolling elements make contact with the inner running surface and an end portion extending from an end of the center portion at an obtuse angle.

15. The unbalanced shaft according to claim 12, wherein the second solid bearing segment includes a second projection and the first solid bearing segment include a second recess complementary to the second projection, the second projection extending into the second recess.
